(19) United States
(12) Patent Application Publication
(10) Pub. No.: US 2010/0074754 A1
(43) Pub. Date: Mar. 25, 2010

(54) Securing Device For Connecting Blades To Blade-Root Attachment Of Remote-Control Helicopters

(75) Inventor: Shigetada Taya, Yokohama (JP)

Correspondence Address: Wang Law Firm, Inc., 4989 Peachtree Parkway,, Suite 200, Norcross, GA, 30092, US

(73) Assignee: THUNDER TIGER CORPORATION, Taichung (TW)

(21) Appl. No.: 12/233,755

(22) Filed: Sep. 19, 2008

(51) Int. Cl. F03B 3/12

(52) U.S. Cl. 416/210 R

(57) ABSTRACT

A remote-control helicopter rotor mechanism includes a rotor with multiple blade-root attachments and each blade-root attachment includes a slot located between two arms. Each arm includes two clamping surfaces and a recess which is defined longitudinally in an inside thereof and located between the two clamping surfaces. Multiple blades each have an elongate body and a root, the root has two protrusions extending from two opposite sides thereof and a passage is defined through the two protrusions and the root. The root inserted into the slot of the blade-root attachment corresponding thereto and a screw extends through the two arms and the passage of the root to connect the root within the slot. The protrusions are matched with the recesses of the two arms and the two clamping surfaces are matched with surfaces of the root.

### FIELD OF THE INVENTION

The present invention relates to a securing device for securely connecting blades to the blade-root attachment of a remote-control helicopter by providing more clamping areas.

### BACKGROUND OF THE INVENTION

Generally speaking, the movement of a remote-control helicopter will be affected if the rotor blades are not well connected to the blade-root attachment and/or the tail-rotor attachment. The connection between the blades of the main rotor or tail rotor is crucial for the quality of control of the remote-control helicopters.

FIGS. 5 and 6 show the conventional connection between the blades 8 and the blade-root attachment 7 which includes a slot 72 located between two arms 73 and each arm 73 has a recess 74 defined longitudinally therein so as to form two clamping surfaces 76 on two sides of the recess 74. A connection bolt 71 extends through a root portion of the blade-root attachment 7 and the rotor is connected with another blade-root attachment 7. Each arm 73 further includes a connection hole 75 defined therethrough and communicating with the slot 72.

The blade 8 includes a root 82 and a passage 81 is defined through the root 82. The root 82 is inserted into the slot 72 and a screw extends through the connection holes 75 in the two arms 73 and the passage 81 to connect the root 82 of the blade 8 to the blade-root attachment 7. The root 82 is clamped by the two clamping surfaces 76 and there are two gaps between the inner surfaces of the recesses 74 of the arms 73 and the root 82. The blades 8 are applied by a significant force by the air when the blades 8 rotate at high speed, the conventional way for connecting the blades 8 to the blade-root attachments 7 obviously cannot provide sufficient clamping areas and force to keep the connection between the blades 8 and the blade-root attachments 7.

The present invention intends to provide a securing device for connecting a blade to a blade-root attachment of a remote-control helicopter, wherein the root of the blade is matched with the recesses of the two arms of the blade-root attachment so that the blade can bear high torque and force during operation.

### SUMMARY OF THE INVENTION

The present invention relates to a securing device for connecting a blade to a blade-root attachment of a remote-control helicopter, the blade-root attachment includes a slot located between two arms and each arm has two clamping surfaces and a recess which is defined longitudinally in an inside thereof and located between the two clamping surfaces. Each arm has a connection hole defined therethrough and the connection holes communicate with the slot. The blade includes an elongate body and a root which has two protrusions extending from two opposite sides thereof. A passage is defined through the two protrusions and the root. The root is inserted into the slot of the blade-root attachment and a screw extends through the connection holes and the passage to connect the root within the slot. The protrusions are matched with the recesses of the two arms and the two clamping surfaces are matched with surfaces of the root.

The primary object of the present invention is to provide a connection device which includes protrusions extending from two opposite sides of the root of the blade so as to be snugly matched with the recesses of the arms of the blade-root attachment. By this arrangement, the blade can be securely connected to the blade-root attachment with more contact area.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the blade and the blade-root attachment of a remote-control helicopter main rotor mechanism of the present invention;

FIG. 2 is a cross sectional view to show the connection between the protrusions on the root of the blade and the arms of the blade-root attachment of the present invention;

FIG. 3 is an exploded view to show the blade and the blade-root attachment of a remote-control helicopter tail rotor mechanism of the present invention;

FIG. 4 is an exploded view to show another embodiment of the blade and the blade-root attachment of a remote-control helicopter main rotor mechanism of the present invention;

FIG. 5 is an exploded view to show the conventional blade and the blade-root attachment of a remote-control helicopter main rotor mechanism, and

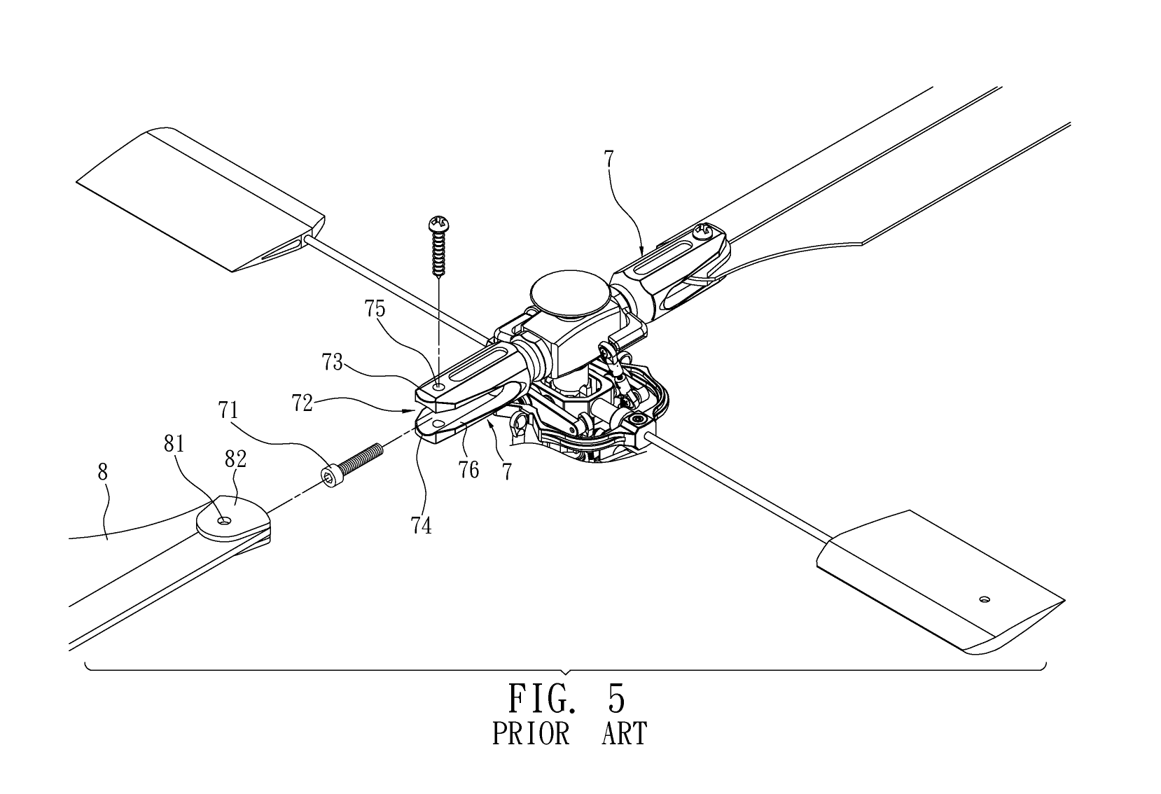

FIG. 6 is a cross sectional view to show the connection between the root of the conventional blade and the arms of the blade-root attachment.

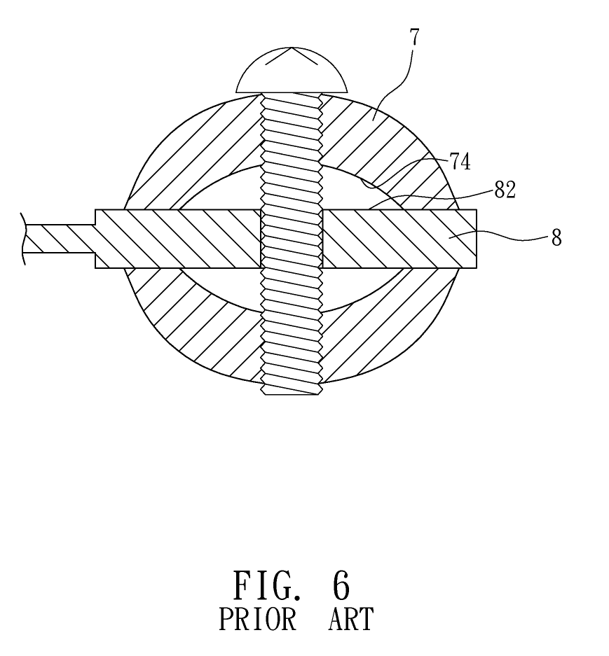

### DETAILED DESCRIPTION OF THE PREFERRED EMBODIMENT

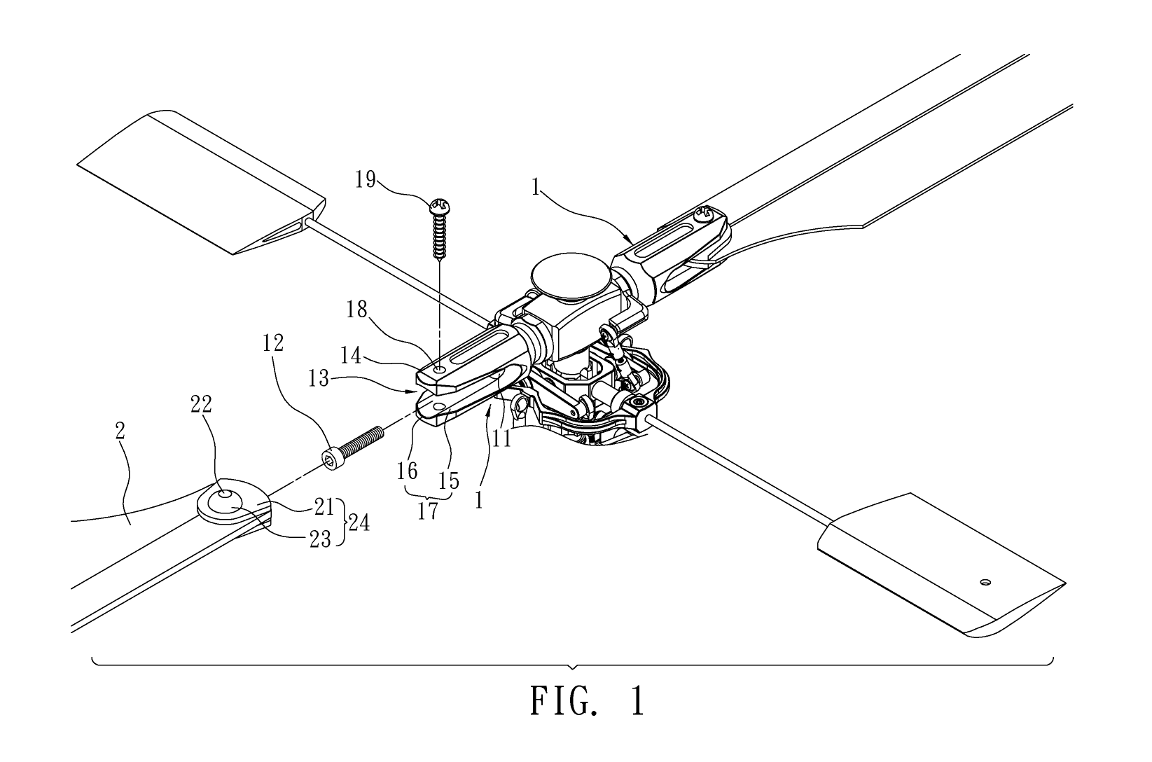

Referring to FIG. 1, the remote-control helicopter rotor mechanism of the present invention comprises a main rotor with two blade-root attachments 1 and each blade-root attachment 1 includes a slot 13 located between two arms 14. Each arm 14 includes two clamping surfaces 15 and a recess 16 which is defined longitudinally in an inside thereof and located between the two clamping surfaces 15. The recess 16 and the clamping surfaces 15 form a first contact surface 17. Each arm 14 has a connection hole 18 defined therethrough and the connection holes 18 communicate with the slot 13. A securing bolt 12 extends through a threaded hole 11 defined axially in the root portion of the blade-root attachment 1 and is connected to the other blade-root attachment 1 as disclosed in FIG. 1.

Two blades 2 are connected to the blade-root attachments 1 and each blade 2 has an elongate body and a root 21 which has two protrusions 23 extending from two opposite sides thereof. A passage 22 is defined through the two protrusions 23 and the root 21. Each of the two protrusions 23 has a curved surface and the curvature of the two protrusions 23 is the same as the curvature of the two recesses 16. The surface of each side of the root 21 and the surface of the protrusion 23 on that side form the second contact surface 24.

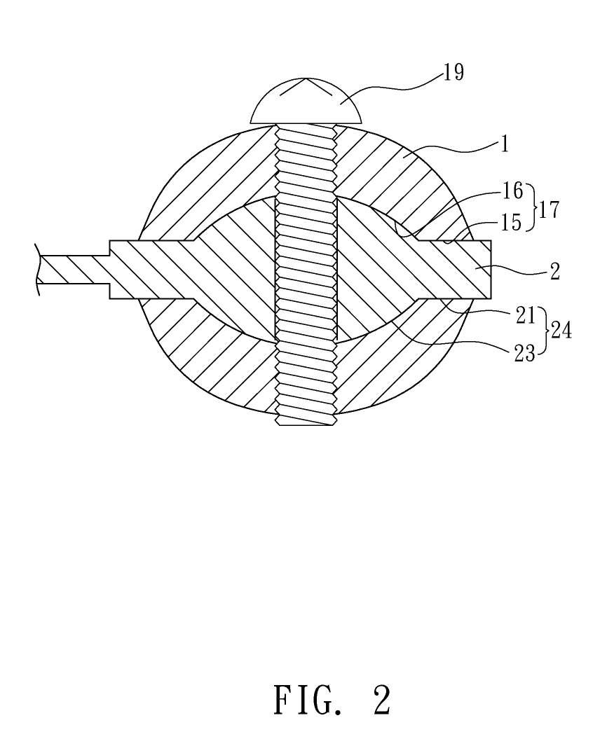

Further referring to FIG. 2, the root 21 is inserted into the slot 13 of the blade-root attachment 1 corresponding thereto and a screw 19 extends through the connection holes 18 and the passage 22 to connect the root 21 within the slot 13. The protrusions 23 are matched with the recesses 16 of the two arms 14 and the two clamping surfaces 15 are matched with surfaces of the root 21. The first contact surface 17 is matched with the second contact surface 24 so that the blade 2 is securely connected to the blade-root attachment 1. The contact area between the blade 2 and the blade-root attachment 1 is much more than the conventional connection so that the connection between the blade 2 and blade-root attachment 1 is improved.

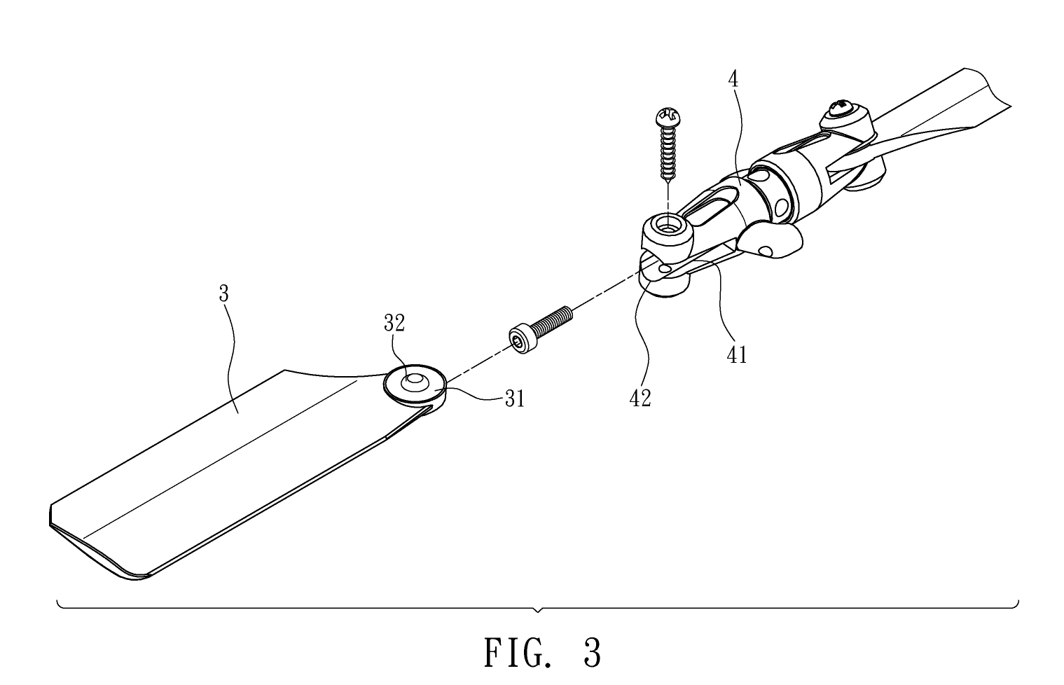

FIG. 3 shows that the same connection method can be used to connect the blade 3 to the blade-root attachment 4 of the tail rotor mechanism. The root 31 of the blade 3 includes a protrusion 32 on each side of the root 31 and a passage is defined through the protrusions 32 and the root 31. The blade-root attachment 4 of the tail rotor mechanism includes two arms and each arm includes a recess 42 and two clamping surfaces 41. The protrusions 32 can be snugly matched with the recesses 42 and the root 31 is clamped between the two clamping surfaces 41.

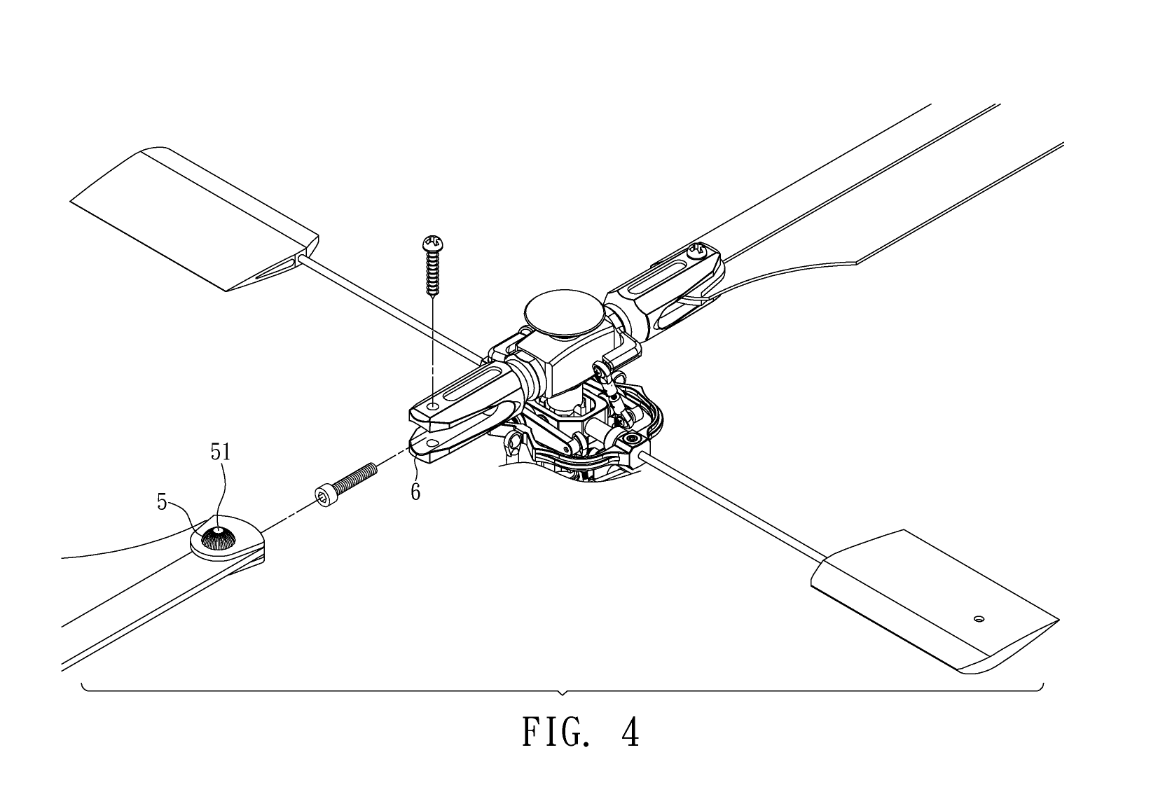

FIG. 4 shows that the protrusions 5 can be made to have a serrated surface and a passage 51 defined through a center of the protrusions 5. The recess 6 of each of the arms of the blade-root attachment has serrated inner surface so that the protrusions 5 can be securely matched with the recesses 6. The serrated surface may include multiple radial ridges as shown.

While we have shown and described the embodiment in accordance with the present invention, it should be clear to those skilled in the art that further embodiments may be made without departing from the scope of the present invention.

What is claimed is:

1. A remote-control helicopter rotor mechanism, comprising:
a rotor with multiple blade-root attachments and each blade-root attachment including a slot located between two arms, each arm having two clamping surfaces and a recess which is defined longitudinally in an inside thereof and located between the two clamping surfaces, each arm having a connection hole defined therethrough and the connection holes communicating with the slot, and
multiple blades connected to the blade-root attachments and each blade having an elongate body and a root which has two protrusions extending from two opposite sides thereof, a passage defined through the two protrusions and the root, the root inserted into the slot of the blade-root attachment corresponding thereto and a screw extending through the connection holes and the passage to connect the root within the slot, the protrusions being matched with the recesses of the two arms and the two clamping surfaces being matched with surfaces of the root.

2. The mechanism as claimed in claim 1, wherein a curvature of the two protrusions is the same as a curvature of the two recesses.

3. The mechanism as claimed in claim 1, wherein each of the two protrusions has a curved surface.

4. The mechanism as claimed in claim 1, wherein each of the two protrusions has a serrated surface.

5. The mechanism as claimed in claim 1, wherein the rotor is a main rotor.

6. The mechanism as claimed in claim 1, wherein the rotor is a tail rotor.
